(19) United States
(12) Patent Application Publication
(10) Pub. No.: US 2017/0006343 A1
(43) Pub. Date: Jan. 5, 2017

(54) SYSTEMS AND METHODS FOR GENERATING RECOMMENDATIONS BASED ON A VIRTUAL ENVIRONMENT

(71) Applicant: Rovi Guides, Inc., Santa Clara, CA (US)

(72) Inventors: Ashleigh Miller, Denver, CO (US); Mario M. Sanchez, San Jose, CA (US); Phillip H. Teich, Pasadena, CA (US); Carla Mack, Los Angeles, CA (US)

(21) Appl. No.: 14/788,096

(22) Filed: Jun. 30, 2015

(51) Int. Cl. H04N 21/466; H04N 21/45; H04N 21/435; H04N 21/472; H04N 21/431; G06F 3/0484; H04N 21/442

(52) U.S. Cl. CPC H04N 21/4668; G06F 3/04845; G06F 3/04842; H04N 21/4667; H04N 21/4532; H04N 21/44204; H04N 21/47205; H04N 21/4316; H04N 21/435

(57) ABSTRACT

Systems and methods are provided herein for providing virtual recommendations based on properties of virtual objects. In some embodiments, user input circuitry may receive an input to place a first virtual object at a first location in a virtual environment. Control circuitry may determine first metadata associated with the first location. Control circuitry may cross-reference the first metadata with data entries of a database. Control circuitry may determine a characteristic associated with the first location, and interpolate a preference of the user based on the characteristic and an identity of the first virtual object. In some embodiments, a recommendation of a first media asset is generated for display based on the preference of the user.

### BACKGROUND

Virtual reality has become the focus of increased attention in recent years. A user of virtual reality systems may adopt a graphical representation (an “avatar”) and interact with virtual objects, environments, and characters in a self-contained universe. Virtual reality systems are applicable to a wide range of industries, such as entertainment, military training, and research. However, existing virtual reality systems largely rely on predetermined design parameters, such as a finite permutation of game plot lines and fixed terrain information. Many of the existing virtual reality systems also lack the capability to recommend media assets to users, both within and outside of the virtual reality world, based on their activities and preferences.

### SUMMARY

Systems and methods are provided herein for making recommendations of media assets based on properties of virtual objects. As an example, a user playing a virtual reality game may purchase virtual posters of celebrities. The celebrities may be a person in real life or a character in the virtual world. Recommendations of media assets, such as on-demand movies or television programs, may be made to the user based on the user's choice of virtual posters as well as the location at which the user places the virtual poster.

To achieve these ends and others, a virtual environment engine (VEE) and a media guidance application (MGA) may be implemented on one or more control circuitry. Systems and methods are provided herein for the VEE running on control circuitry to receive inputs from a user to place a first virtual object at a first location in a virtual environment. For example, the VEE may determine that user input interface circuitry has received input from a user to place a virtual poster of an anime character in a virtual closet. For various reasons, the user may not wish to make the poster publicly available to other users.

In some embodiments, the VEE may determine first metadata associated with the first location. For example, the VEE may determine that the virtual closet in which the anime poster is stored has the coordinates of (x1, y1) in the virtual environment.

In some embodiments, the VEE may cross-reference the first metadata with data entries of a first database. The first database may be a database of virtual objects (e.g., a virtual object database, or VODB), and may be implemented locally or on a remote server. In some embodiments, the first database may be used to store data entries of metadata associated with locations in the virtual environment, such as coordinates, genre, function, structure, and appearance of each location. For example, the VEE may cross-reference the coordinates of the virtual closet (x1, y1) with entries in the first database (e.g., the VODB) in order to find a match and subsequently extract the associated characteristics of the virtual closet from the first database.

In some embodiments, the VEE may determine a characteristic associated with the first location based on the cross-referencing. For example, the VEE may extract a characteristic associated with the virtual closet by cross-referencing the coordinates of the virtual closet against the first database (e.g., the VODB), and determine that the virtual closet has a characteristic of “private and hidden.”

In some embodiments, the VEE may interpolate a preference of the user based on the characteristic and an identity of the first virtual object. In the setting of the above example, the VEE determines that the virtual closet has a characteristic of “private and hidden.” In addition, the VEE may determine an identity of the virtual poster to be an “anime character,” using metadata associated with the virtual poster. As a result, the VEE may interpolate that one preference that the user has may be to “watch Japanese anime in private” based on the characteristic (i.e., “private and hidden”) and the identity of the poster (i.e., “anime character”).

In some embodiments, the VEE may communicate the characteristic of the virtual object, the preference of the user, and the identity of the virtual object to an MGA. The MGA may be implemented on control circuitry, which may be the same control circuitry that the VEE is implemented on, or different control circuitry. In some embodiments, recommendation of a first media asset associated with the first virtual object may be generated for display based on the preference of the user. In some embodiments, the recommendation of the first media asset may be generated by the MGA, by querying a second database, such as a database of media assets (e.g., a media asset database, or MDB). Following the above example, the MGA may recommend a new episode of a Japanese anime to the user, based on the user's preference to “watch Japanese anime in private” as interpolated by the VEE. The MGA may send the user's preference as a query to the second database (e.g., an MDB) in order to receive a list of recommendations in line with the user's preference. The MGA may generate the new episode for display on an electronic device, such as a user television equipment. Alternatively, the MGA may generate the new episode for display in a virtual electronic equipment in the virtual environment. In some embodiments, the MGA may communicate the identity and other metadata of the recommended new episode back to the VEE for further processing.

In some embodiments, the VEE may determine whether the first location is within an area of the virtual environment that is subject to access control by the user. In some embodiments, an area of the virtual environment that is subject to access control by the user may be an area that is owned by the user. For example, the VEE may determine whether the virtual closet is owned by the user, or otherwise subject to access control configured by the user such that other users will not be able to access the virtual closet unless they are authorized by the user.

In some embodiments, based on the determination that the first location is within the area of the virtual environment subject to access control by the user, either the VEE or the MGA may cause recommendation of the first media asset to be generated for display to users who have access to the area of the virtual environment subject to access control by the user. For example, the virtual closet having a characteristic of “private and hidden” may be in an area that is subject to access control by the user. Consequently, the new episode will be recommended, by the MGA, only to users who also have access to the virtual closet as determined by the VEE.

In some embodiments, the MGA may determine whether the user has accessed the first media asset subsequent to when the recommendation is generated for display. The MGA may determine that the user has accessed the first media asset if the user has clicked, purchased, scheduled to record, set a reminder for, or otherwise manipulated the first media asset. For example, the MGA may monitor the user's interactions with the recommended new episode and determine that the user has chosen to purchase an on-demand copy of the new episode. In another example, the MGA may determine that the user has accessed the new episode if the user has set a reminder to watch the new episode on a television equipment at a future time. Alternatively, the VEE may receive user interactions data from the MGA to carry out the above steps of determining whether the user has accessed the first media asset subsequent to when the recommendation is generated for display.

In some embodiments, the identity of the first virtual object, the identity of the recommended first media asset, and the first location may all be associated with each other in the database. The VEE may strengthen or weaken the associations among the first virtual object, the first media asset, and the first location depending on a number of factors. In one aspect, based on determining that the user has accessed the first media asset, the VEE may strengthen an association between the first virtual object and the first media asset. For example, once the MGA or the VEE determines that the user has accessed the recommended new episode, the VEE may cause the association between the “anime poster” and the “episode of Japanese anime” to be strengthened because the user has followed the recommendation.

In another aspect, based on determining that the user has accessed the first media asset, the VEE may strengthen an association between the first virtual object and the first location. For example, once the MGA or the VEE determines that the user has accessed the recommended new episode, the VEE may cause the association between the “anime poster” and the “virtual closet” to be strengthened because the user has followed the recommendation which was generated based on an existing association between “anime poster” and “virtual closet.”

In some embodiments, the VEE may determine that user input interface circuitry has received input from the user to move the first virtual object from the first location to a second location in the virtual environment. For example, the VEE may determine that user input circuitry has received input from the user to move the anime poster from the virtual closet to a virtual living room.

In some embodiments, the VEE may determine second metadata associated with the second location and cross-reference the second metadata with the data entries of the first database (e.g., the VODB). Following the above example, the VEE may determine that the virtual living room in which the anime poster is stored has coordinates of (x2, y2) in the virtual environment. The VEE may cross-reference the coordinates of the virtual living room (x2, y2) with the data entries in the first database in order to find a match and subsequently extract an associated characteristic of the virtual living room from the first database.

In some embodiments, the VEE may determine, based on the cross-referencing, a characteristic associated with the second location. For example, the VEE may determine that a characteristic associated with the second location is “public” because the virtual living room does not have any access control or access restriction associated with it. The VEE may determine that any user may access the virtual living room, and consequently any user may access virtual objects displayed in the virtual living room.

In some embodiments, the VEE may communicate the characteristic associated with the second location to the MGA, and cause the MGA to generate for display a recommendation of a second media asset in the virtual environment based on the characteristic. For example, the VEE may send the “public” characteristic of the virtual living room, along with any other relevant metadata, to the MGA, such that the MGA generates for display a recommendation of a documentary on the history of Japanese anime culture.

In some embodiments, the VEE may determine whether the second location is within an area of the virtual environment that is subject to access control by the user. As illustrated previously, the area of the virtual environment that is subject to access control by the user may be an area that is owned by the user. For example, the VEE may determine whether the virtual living room is an area owned by the user. In this example, the VEE determines that the virtual living room is not owned by the user, and therefore the living room is not within the area of the virtual environment that is subject to access control by the user.

In some embodiments, the VEE may determine a first distance between the first virtual object and the first location, and determine a second distance between the first virtual object and a second location. For example, the VEE may determine that the anime poster is 5 units of distance from a first virtual location, and that the anime poster is 3 units of distance from a second virtual location.

In some embodiments, the VEE may determine that the second distance is shorter than the first distance, and may retrieve second metadata associated with the second virtual location from the second database (e.g., the VODB). For example, the VEE may determine that the distance between the anime poster from the second virtual location (i.e., 3 units of distance) is shorter than the distance between the anime poster from the first virtual location (i.e., 5 units of distance). In response, the VEE may retrieve metadata associated with the second virtual location. The metadata associated with the second virtual location may be an identity of the second virtual location (e.g., a virtual workstation).

In some embodiments, the VEE may determine, based on the second metadata, a characteristic associated with the second virtual location. For example, the VEE may determine that one characteristic associated with the virtual workstation is the hours of working activities (e.g., 8:00 AM-6:00 PM).

In some embodiments, the VEE may communicate the characteristic associated with the second virtual location and an identity of the first virtual object to the MGA, such that the MGA may generate for display a recommendation of a second media asset based on the characteristic and the identity. For example, the MGA may generate for display a recommendation for a new episode of an anime for the user to view on television equipment during the hours of 8:00 AM and 6:00 PM. In this manner, the MGA recommends the new episode based on the characteristic associated with the virtual workstation (i.e., the working hours) and the identity of the first virtual object (i.e., the anime poster).

In some embodiments, based on determining that the second location is not within the area of the virtual environment subject to access control by the user, the VEE may cause the MGA to generate a recommendation for the second media asset for display for users, such that the users who are not entitled to access the area of the virtual environment that is subject to the access control can still view the recommendation. For example, a user who is not entitled to enter the virtual closet owned by the user may nevertheless be able to view the recommendation for the second media asset generated for display by the MGA, because the virtual anime poster (based on which the recommendation for the second media asset is made) has been moved from the virtual closet to the virtual living room.

In some embodiments, the VEE may receive input from a “different user” to place a second virtual object at the second location. For example, the “different user” may place a movie poster (e.g., a movie poster for Star Wars) in the virtual living room.

In some embodiments, the VEE may interpolate a preference of the “different user” based on the characteristic associated with the second location and an identity associated with the second virtual object. For example, the VEE may determine that a characteristic of the virtual living room is “public,” similar to the determination made in the previous example. In addition, the VEE may determine that an identity associated with a Star Wars poster is “science fiction.” Consequently, the VEE may interpolate a preference for the “different user” based on the “public” characteristic of the virtual living room and the “science fiction” identity of the Star Wars poster, and may determine that the preference of the “different user” may be to “watch science fiction movies in public.”

In some embodiments, the VEE may correlate the preference of the user with the preference of the “different user” to calculate a shared preference metric between the user and the “different user.” Following the scenario of the above examples, the VEE may correlate the preference of the user (“watch Japanese anime in private”) with the preference of the “different user” (“watch science fiction movies in public”) to calculate a shared preference metric between the two users. For example, based on the above, the VEE may determine that both the user and the “different user” have a preference for watching a video asset. Additionally, control circuitry may determine that an intersection between the user's preference for Japanese anime and the different user's preference for science fiction movies is “Japanese science fiction.” Consequently, the VEE may determine that the shared preference metric between the user and the “different user” may be to “watch Japanese science fiction.”

In some embodiments, the VEE may communicate the shared preference metric of the user and the “different user” to the MGA. The MGA may generate for display, on a user equipment device, a recommendation of a third media asset for both the user and the “different user” based on the shared preference metric. For example, the MGA may generate for display a recommendation for a Japanese science fiction movie, such as Mobile Suit Gundam SEED, for both the user and the “different user,” on a television equipment that is accessible by both the user and the “different user.” Alternatively, the recommendation may be generated separately for the user and the “different user” on different user equipment devices. In some embodiments, the VEE may generate for display the recommendation in the virtual environment, such as on a virtual workstation.

In some embodiments, the VEE may determine that user input circuitry has received, from the user, a selection of a scene from a media asset. For example, the MGA may provide a listing of media assets for the user to browse. Upon receiving an input from the user to select a scene of a movie (e.g., a bedroom scene from Hobbit), the MGA may communicate the identity of the selected scene and extract spatial markers from the selected scene to the VEE. Alternatively, the VEE may generate the listing of media assets for the user to browse and receive a scene selected by the user.

In some embodiments, the VEE may generate a virtual representation of the scene based on the selection. For example, the VEE may generate the virtual representation of a bedroom scene based on the selection of the scene by rendering the extracted spatial markers from the selected scene.

In some embodiments, the VEE may add the virtual representation of the selected scene to the virtual environment. In this manner, the VEE allows the user to populate the virtual environment in a customizable way. For example, the VEE may include the bedroom scene in the virtual environment as a private home for the user's avatar, and define a set of access control rules for the virtual bedroom. In one aspect, the virtual private home generated from the selected bedroom scene may be a virtual environment owned by the user, such that other users may not access the virtual private home (nor media assets recommended thereof) unless permission is granted by the user.

In some embodiments, the VEE may automatically extract metadata from interaction data between the user and various virtual locations within the virtual environment. As illustrated previously, metadata of virtual locations may be coordinates, genre, function, structure, and appearance of each location. In addition, the metadata extracted from user interaction data may be timestamps, user parameters, activity log, purchase records, and any other data generated during a user's interaction with a particular virtual location. For example, the VEE may determine that the user has visited a virtual bookstore 5 times a day for every day of a given week. The VEE may extract the frequency of the user's visits to the virtual bookstore as metadata associated with the virtual bookstore.

In some embodiments, the VEE may populate the first database (e.g., the VODB) with the extracted metadata. In some embodiments, the first database may be a database of virtual objects and virtual locations. For example, the VEE may enter the extracted frequency of the user's visits to the database as a data entry associated with both the user and the virtual bookstore, thereby establishing an association between the user and the virtual bookstore. As an alternative example, the VEE may translate the frequency of the user's visits to a popularity metric and enter the popularity metric into the database as an entry for the virtual bookstore.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative embodiment of a viewing window that may be used to provide media guidance application listings and other media guidance information, in accordance with some embodiments of the disclosure;

FIG. 2 shows another illustrative embodiment of a display screen that may be used to provide media guidance application listings, in accordance with some embodiments of the disclosure;

FIG. 3 is a block diagram of an illustrative user equipment (UE) device in accordance with some embodiments of the disclosure;

FIG. 4 is a block diagram of an illustrative media system in accordance with some embodiments of the disclosure;

FIG. 5 is an illustrative embodiment of a display screen showing a snapshot of a virtual reality environment, in accordance with some embodiments of the disclosure;

FIG. 6 is a flowchart of illustrative steps involved in providing recommendations of media assets based on properties of virtual objects, in accordance with some embodiments of the disclosure;

FIG. 7 is a flowchart of illustrative steps involved in recommending media assets to one or more users based on user preferences, in accordance with some embodiments of the disclosure; and

FIG. 8 is a flowchart of illustrative steps involved in recommending media assets to one or more users based on relative distances of virtual objects and various locations in a virtual environment.

### DESCRIPTION

Systems and methods are provided herein for making recommendations of media assets based on properties of virtual objects. As an example, a user playing a virtual reality game may purchase virtual posters of celebrities. The celebrities may be a person in real life or a character in the virtual world. Recommendations of media assets, such as on-demand movies or television programs, may be made to the user based on the user's choice of virtual posters as well as the location at which the user places the virtual poster.

To achieve these ends and others, a VEE and an MGA may be implemented on one or more control circuitry. As used herein, a “virtual environment” is an artificially created virtual reality space in which one or more users may interact with virtual objects at various virtual locations. The virtual environment may, in some embodiments, be run on the VEE. The VEE may provide means for various users to engage in virtual activities within the virtual environment, and may communicate with the MGA in providing media asset recommendations to the users outside of the virtual environment (e.g., on a real world user electronic device).

Systems and methods are provided herein for the VEE running on control circuitry to receive inputs from a user to place a first virtual object at a first location in virtual environment. For example, the VEE may determine that user input interface circuitry has received input from a user to place a virtual poster of an anime character in a virtual closet. For various reasons, the user may not wish to make the poster publicly available to other users.

In some embodiments, the VEE may determine first metadata associated with the first location. For example, the VEE may determine that the virtual closet in which the anime poster is stored has coordinates of (x1, y1) in the virtual environment.

In some embodiments, the VEE may cross-reference the first metadata with data entries of a first database. The first database may be a database of virtual objects (e.g., a virtual object database, or VODB), and may be implemented locally or on a remote server. In some embodiments, the first database may be used to store data entries of metadata associated with locations in the virtual environment, such as coordinates, genre, function, structure, and appearance of each location. For example, the VEE may cross-reference the coordinates of the virtual closet (x1, y1) with entries in the first database (e.g., the VODB) in order to find a match and subsequently extract the associated characteristics of the virtual closet from the first database.

In some embodiments, the VEE may determine a characteristic associated with the first location based on the cross-referencing. For example, the VEE may extract a characteristic associated with the virtual closet by cross-referencing the coordinates of the virtual closet against the first database (e.g., the VODB), and determine that the virtual closet has a characteristic of “private and hidden.”

In some embodiments, the VEE may interpolate a preference of the user based on the characteristic and an identity of the first virtual object. In the setting of the above example, the VEE determines that the virtual closet has a characteristic of “private and hidden.” In addition, the VEE may determine an identity of the virtual poster to be an “anime character,” using metadata associated with the virtual poster. As a result, the VEE may interpolate that one preference that the user has may be to “watch Japanese anime in private” based on the characteristic (i.e., “private and hidden”) and the identity of the poster (i.e., “anime character”).

In some embodiments, the VEE may communicate the characteristic of the virtual object, the preference of the user, and the identity of the virtual object to an MGA. The MGA may be implemented on control circuitry, which may be the same control circuitry that the VEE is implemented on, or different control circuitry. In some embodiments, a recommendation of a first media asset associated with the first virtual object may be generated for display based on the preference of the user. In some embodiments, the recommendation of the first media asset may be generated by the MGA, by querying a second database, such as a database of media assets (e.g., an MDB). Following the above example, the MGA may recommend a new episode of a Japanese anime to the user, based on the user's preference to “watch Japanese anime in private” as interpolated by the VEE. The MGA may send the user's preference as a query to the second database (e.g., an MDB) in order to receive a list of recommendations in line with the user's preference. The MGA may generate the new episode for display on an electronic device, such as a user television equipment. Alternatively, the MGA may generate the new episode for display in a virtual electronic equipment in the virtual environment. In some embodiments, the MGA may communicate the identity and other metadata of the recommended new episode back to the VEE for further processing.

Interactive media guidance applications (MGA) may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance. Furthermore, as referred herein, the term “in response to” refers to initiated as a result of. For example, a first action being performed in response to another action may include interstitial steps between the first action and the second action. As referred herein, the term “directly in response to” refers to caused by. For example, a first action being performed directly in response to another action may not include interstitial steps between the first action and the second action.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

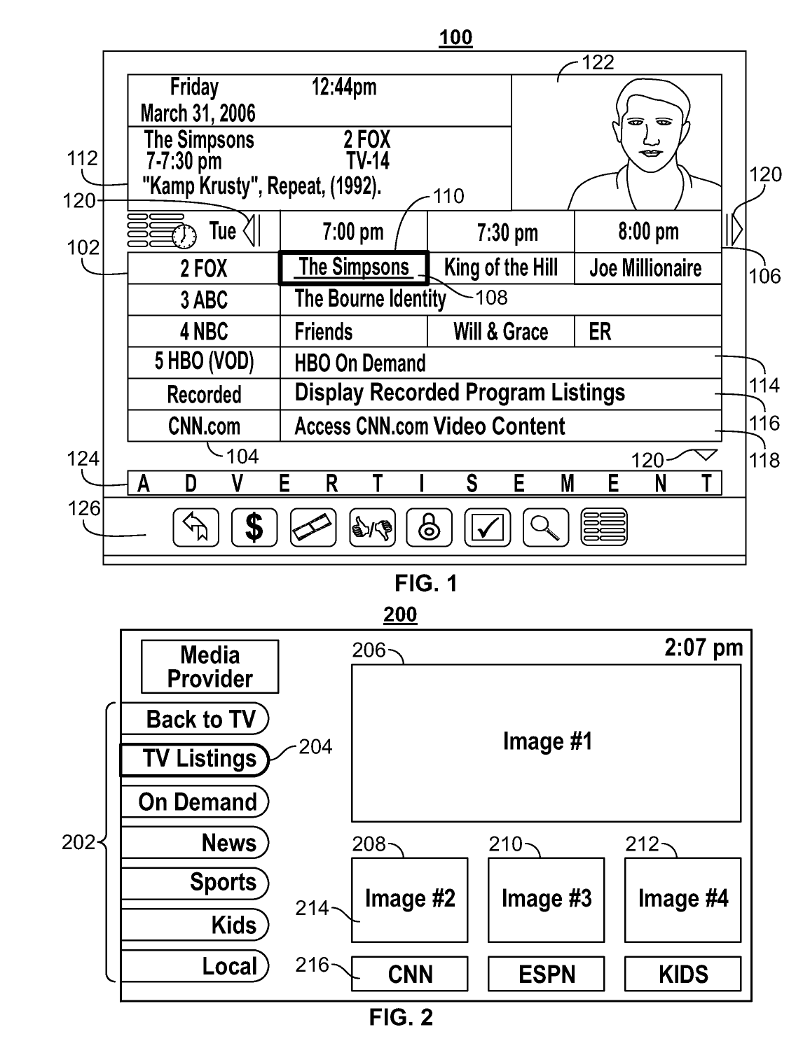

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application (MGA) may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

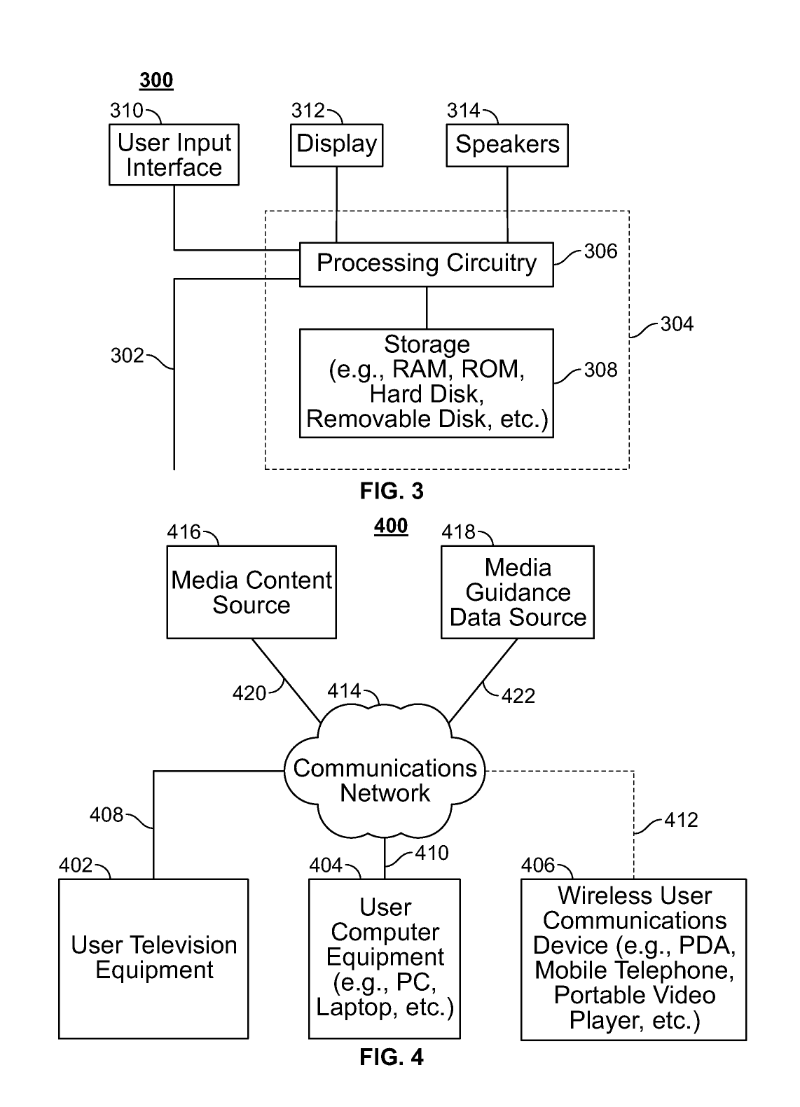

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct control circuitry 304 to generate the guidance application displays and transmit the generated displays to the user equipment devices. The server application may instruct control circuitry 304 of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YouTube, Netflix, Amazon Instant Video, and Hulu, which provide audio and video via IP packets. YouTube is a trademark owned by Google Inc., Netflix is a trademark owned by Netflix Inc., Amazon Instant Video is a trademark owned by Amazon.com, Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

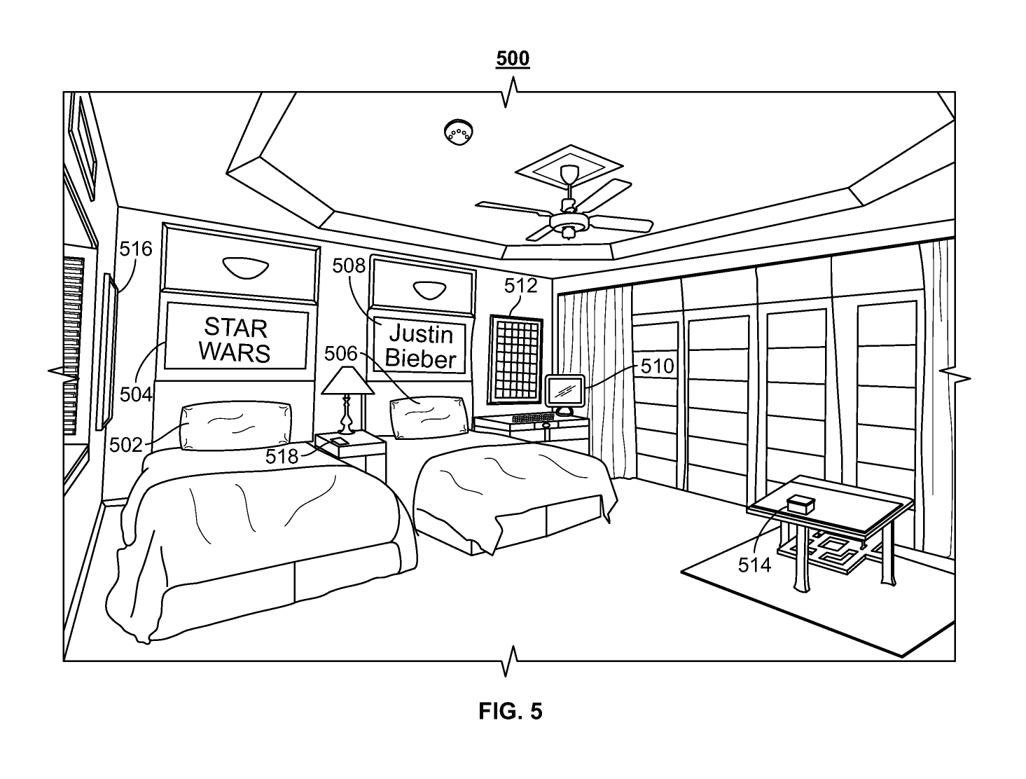

FIG. 5 is an illustrative embodiment of a viewing window 500 showing a snapshot of a virtual reality environment, in accordance with some embodiments of the disclosure. In some embodiments, a virtual environment engine (VEE) running on control circuitry 304 may cause viewing window 500 to display the snapshot as shown in FIG. 5. In some embodiments, a media guidance application (MGA) that is substantially similar to the MGA described in relation to FIGS. 1 and 2 may also run on control circuitry 304 to provide guidance of media assets. In some embodiments, the VEE and the MGA may run on separate control circuitry, on separate user equipment devices, or on different cloud-based servers.

The VEE running on control circuitry 304 may determine that user input has been received, e.g., by user input interface circuitry 310, to navigate the instantaneous view as presented in FIG. 5. The VEE may, in response to user input to navigate, cause viewing window 500 to move in any direction such that the viewing window of FIG. 5 pans along the vertical or horizontal planes in order to explore the virtual reality environment. The VEE may additionally zoom in and zoom out of viewing window 500 of FIG. 5 in response to additional user input.

Within the instantaneous snapshot of viewing window 500 in FIG. 5, the VEE may cause display screen 500 to display a number of virtual objects in the virtual environment, such as virtual posters 504 and 508, virtual beds 502 and 506, virtual electronic device 510, virtual closets 512 and 516, and other virtual objects 514 and 518. It is understood that the snapshot shown in FIG. 5 is merely illustrative of a virtual environment and is by no means limiting. The virtual environment can be any virtual space with usable real estate or objects and asset placement.

The VEE may receive instructions from the user, e.g., by way of user input interface circuitry 310, to interact with the virtual objects as well as other users of the virtual environment. For example, the VEE may determine that a first user's avatar sleeps on virtual bed 502 during the evening and a second user's avatar sleeps on virtual bed 506 during the day. The VEE may further determine that the first user places virtual poster 504 depicting a Star Wars character above his virtual bed 502, whereas the second user places virtual poster 508 about a celebrity above her virtual bed 506.

In some embodiments, the VEE may receive user instruction to place a virtual object in a hidden or private area, such as private closet 512, such that only the user has access to the virtual object. For example, the VEE may fulfill the desire of a teenage anime fan, who does not wish to publicly display his virtual collection of genre-related items (e.g., anime and comic books), by providing virtual closet 512 for the user to hide his virtual collection. Virtual closet 516 may serve a similar purpose for a different user.

In some embodiments, the VEE may provide virtual electronic device 510 for the user to view and access media assets. For example, the VEE may allow the user to purchase television programs, movies, VOD media, PPV media, games, music, or any other media assets within the virtual environment and view the media assets using virtual electronic device 510. The VEE may additionally allow users to interact with other users using virtual electronic device 510, as one would interact with other people in real life using instant messaging or video-calling software on a computer device.

Virtual objects 514 and 518 may be any object suitable for the environment as depicted in viewing window 500. For instance, virtual object 514 may be a collection box of virtual artifacts such as badges and stickers that a user has exchanged with other users. The VEE may receive user instruction to place virtual object 514 at a corner of the room (i.e., the virtual environment), away from virtual beds 502 and 506, and virtual electronic device 510, where the user usually spends the most time. Virtual object 518 may be a virtual reminder slip for a book that is scheduled to be released soon. The VEE may receive user instruction to place the virtual reminder slip close to where the user's avatar rests at night.

In some embodiments, the VEE may use the virtual location of a virtual object to determine preferences of the user. For instance, the VEE may determine that a collection of anime and comic books kept in a hidden location, such as virtual closet 512 or 516, may indicate that the corresponding user does not wish to let other users access or become aware of the collection. Consequently, the VEE may recommend other virtual objects (including media assets) based on the hidden virtual objects only if the user is in a completely private location.

In some embodiments, the VEE may use the relative positions of two or more virtual objects, or the relative locations of the virtual object and the user, to determine the preferences of the user. For example, the VEE may determine that virtual object 514 is physically removed from all other virtual objects that the user owns and interacts with often. As a result, the VEE may assign a lower importance level to virtual object 514 as compared to the other virtual objects. As another example, the VEE may determine that virtual electronic device 510 is further removed from the user than virtual object 518. The VEE may, based on the determination, assign a higher importance level to virtual object 518.

The VEE may cause a virtual object to be associated with other virtual objects, media assets, or virtual locations, in a number of manners. For example, the VEE may cause the virtual objects, media assets, and virtual locations to be associated by their respective functionality as well as the history of a user's interaction with the virtual objects, the media assets, and the virtual locations. The VEE may enter the association between two virtual objects and the association between a virtual object and a virtual location into a virtual object database (i.e., a VODB), such as storage 308 or media guidance data source 418. The VEE may additionally enter the association between various media assets and the virtual objects in the VODB. Similarly, the MGA may enter metadata associated with the various media assets in a media assets database (i.e., an MDB), such as local storage 308 or media guidance data source 418. In some embodiments, the VEE and the MGA may determine that the aforementioned associations are either strengthened or weakened based on user interaction received, e.g., using user input interface circuitry 310. For example, after a user has selected a first virtual object, the VEE may extract metadata and a characteristic associated with the first virtual object, as well as preferences of the user, and communicate the metadata, characteristics, and preferences to the MGA. The MGA may query the MDB and recommend a first media asset to the user based on the selection and a shared characteristic between the first virtual object and the first media asset. If the MGA determines that the user has accessed the recommended first media asset subsequent to the recommendation, the MGA may send a notification to the VEE, such that the VEE may strengthen the association between the first virtual object and the shared characteristic, and strengthen the association between the first media asset and the shared characteristic.

As another example, the MGA may determine that the user has accessed a media asset that is recommended after the user chooses to access a first virtual object at a virtual location. The VEE may, based on the determination, strengthen associations among the first virtual object, the virtual location, and the recommended media asset in the VODB and the MDB.

In some embodiments, the VEE and the MGA may maintain a profile for each user. In particular, the VEE may include the virtual objects and virtual locations that a user accesses or receives in the user's profile. The VEE may additionally include virtual objects, media assets, and virtual locations that are owned by or created by the user in the user's profile. In some embodiments, the VEE may maintain the user's profile in the VODB, such as one that is implemented as storage 308 or media guidance data source 418. In some embodiments, the user profiles may be used by the VEE to determine preferences of the user.

In some embodiments, the VEE may include the importance level associated with each virtual object (e.g., as discussed above in relation to virtual object 514 and virtual object 518) in profiles of users. The VEE may additionally adjust (e.g., increase or decrease) the importance levels of virtual objects based on activities of the user. For example, a user may replace virtual poster 504 (e.g., Star Wars) with another virtual poster depicting another movie (e.g., Guardians of the Galaxy). As a result, the VEE may increase the importance level of “Guardians of the Galaxy” in the user's profile, and decrease the importance level of “Star Wars” in the user's profile. Consequently, the MGA may rely on the “Guardians of the Galaxy” more than the “Star Wars” to recommend media assets to the user.

In some embodiments, the VEE may determine additional preferences of the user's based on the user's activities (e.g., adding or removing a virtual object). The VEE may use the added or removed virtual object to fine tune the user preference profile previously established with the existing virtual objects. For example, a user's bedroom decorated with a virtual poster of Star Wars may indicate a range of preferences of the user's, such as science-fiction, fantasy, Natalie Portman, George Lucas, and so on. If the user later adds two additional virtual posters (e.g., Guardians of the Galaxy and Gravity), the VEE may determine that the user has strong preference for “science-fiction” because all three virtual posters belong to the genre of science-fiction. The VEE may additionally reduce the importance level of “Natalie Portman” and “George Lucas” in the user's profile because they are not related to the newly-added virtual posters. Lastly, if the user adds another virtual poster (e.g., Wall-E), the VEE may begin to include “animated film” into the user's preference profile.

In some embodiments, the VEE may use the profiles of multiple users to determine a shared preference metric of the multiple users. In the event that two or more users are present in a virtual location, such as a virtual living room, the VEE may determine a first user's preference from the first user's profile, and a second user's preference from the second user's profile. Upon determining the user preferences, the VEE may find intersections between the user preferences to determine the shared interest metric between the first and second users, and use the shared interest metric to determine recommendations of virtual objects (including media assets) to the users.

In some other embodiments, the VEE may determine a time of day for the user, and use the time-of-day information in interpolating the user's preferences for virtual objects and other media assets. The VEE may calculate the time-of-day information based on the schedule of the user's avatar in the virtual environment, or based on the schedule of the user in real life. For example, for a first user who keeps a movie virtual poster, such as virtual poster 504, in proximity to his bed (e.g., virtual bed 502) where the user sleeps in the evening, the VEE may determine that the user prefers to enjoy the movie (e.g., Star Wars) and other similar movies during the evening time and by himself or herself. As another example, the VEE may determine that a different user always browses for episodes of a television series on virtual electronic device 510 during 8:00 am-9:00 am every morning. As such, the VEE may determine that this user enjoys television series in the morning, and may cause the MGA to generate recommendations for similar television series to the user during the morning timeframe.

The VEE may additionally associate particular events with various virtual locations in order to determine the user's preference for media assets. For example, the VEE may determine that a virtual bed is often associated with a sleeping event, and that a virtual computer is associated with a working event or a media enjoyment event. As a result, upon determining that a user places a virtual object (e.g., an anime poster) close to a virtual location (e.g., one that is associated with the working event), the VEE may recommend media assets to the user based on the identity of the virtual object and the associated event of the virtual location (e.g., the MGA recommends an anime to the user during working hours). In another example, the VEE may determine that a user always watches Japanese anime programs prior to going to virtual bed 502, and therefore may automatically associate Japanese anime programs with the sleeping event. Upon receiving this association information from the VEE, the MGA may recommend a new episode of Japanese anime to the user, e.g., on the user's television equipment, when the user actually prepares to go to bed.

The VEE may receive user instructions, e.g., by way of user input interface circuitry 310, to customize the virtual environment as depicted in viewing window 500. The VEE may also receive user instructions to convert a scene from a media asset or a photograph of a location in real life into a virtual environment. Lastly, the VEE may receive user instructions to replicate (e.g., copying or mirroring) a virtual setting from a friend's virtual environment. For example, the VEE may receive a copy of a photograph of the user's bedroom and generate a virtual representation of the bedroom. Subsequently, the VEE may incorporate the virtual representation of the bedroom into the virtual environment as, for example, the bedroom as depicted in viewing window 500 of FIG. 5.

In some embodiments, the VEE may receive user instructions to further modify an existing virtual location. The VEE may determine that instructions have been received, e.g., by way of user input interface circuitry 310, from the user, to add a virtual object, remove a virtual object, replace a virtual object, move a virtual object, or otherwise modify settings and objects of the virtual environment. In particular, the VEE may receive user selections of virtual objects and virtual locations from a catalog, such as a product placement catalog, to populate the virtual environment. In an example, the VEE may receive user instructions to move virtual object 514 from the corner of viewing window 500 to virtual bed 502. In this example, the VEE may determine that the movement of virtual object 514 corresponds to a change in the user's preference for virtual object 514 and other similar virtual objects. For example, the VEE may determine that the movement of virtual object 514 indicates that the user is willing to access virtual object 514 in a private area (i.e., on virtual bed 502) during the evening time.

In some embodiments, the VEE may additionally determine how often a virtual object is moved, and cause the MGA to recommend media assets based on the frequency of the movement. For example, if the VEE determines that the user moves virtual object 514 at least 5 times a day, the VEE may assign a higher importance level on virtual object 514 than it does on another virtual object that the user accesses infrequently. In this manner, the VEE may further fine-tune the user's preference and allow the MGA to generate media asset recommendations based on trends of activities undertaken by the user.

It is understood that, although recommendations of virtual objects (including media assets) are described herein as being based on explicit user interactions with existing virtual objects and virtual locations, other intelligent deductions are possible and are well within the scope of the present disclosure. In particular, the VEE may determine, based on a virtual environment created and customized by the user, the mood and theme of the virtual environment and generate a recommendation based on the mood and theme. For example, if the VEE receives user input to create a shady inner-city scene with a favorite celebrity in a vampire role and another favorite celebrity in the role of a detective, the VEE may determine the mood and theme of the inner-city scene to be “dark” and “vampire,” and communicate this mood and theme information to the MGA. Subsequently, the MGA may consult the MDB based on the mood and theme information to find matches, and recommend media assets to the user that resemble or echo these moods and themes.

In some embodiments, the VEE may determine the mood and theme of a virtual environment based on the coloring, decoration, or juxtaposition of virtual objects of the virtual environment. For example, the coloring and decoration of a virtual environment created by the user, such as “bright,” “festive,” or “yellow,” may be used by the VEE to denote a celebratory mood and theme of the virtual environment, and may subsequently be communicated to the MGA to be used for media asset recommendations, such as Love Actually. As another example, the placement of a virtual “broken window” next to a virtual “firearm” may be used to denote a crime scene. The VEE may accordingly communicate these information to the MGA for media asset recommendations related to crime scenes, such as CSI or Criminal Minds.

The VEE constantly monitors the user's interactions with various virtual locations and virtual objects in the virtual environment, and automatically extracts metadata associated with the virtual locations and virtual objects. The metadata extracted may include coordinates of a location, functionality of a location or object, user activities recorded at a location, user interactions with an object, timestamps, frequency of accessing a location or an object, duration of accessing a location or an object, and any other information or data relevant to the user's interactions. Once the metadata is extracted, the VEE may populate data entries of a first database (e.g., the VODB), such as storage 308 or media guidance data source 418, with the extracted metadata.

In some embodiments, the VEE may query the first database (e.g., the VODB) in order to cross-reference metadata of a particular virtual location with data entries in the first database. For example, the VEE may use the metadata of a particular virtual location, such as its coordinates, to cross-reference with data entries in the first database. As a result, the VEE may determine additional characteristics associated with the particular virtual location, such as the name, functionality, access frequency, private/public settings, as well as other properties of the particular virtual location.

Virtual locations within the virtual environment may be subject to access control. In some embodiments, the VEE may receive instructions from the user to configure access control rules for a particular virtual location. For example, the VEE may receive user instructions to set a virtual bedroom as “private”, such that users who are not entitled to access private locations in the virtual environment will not be able to enter the location, and will not be able to access virtual objects or media assets stored at the location. In another example, the VEE may receive user instructions to set a virtual living room as “public”, such that users who are not entitled to access private locations in the virtual environment will still be able to access the virtual living room. It is understood that the designation of “private” and “public” for virtual locations that are subject to access control are merely illustrative and non-limiting, and that other designations or descriptive terms may be used without going beyond the scope of the present disclosure.

In some embodiments, the MGA may generate for display an option for users to receive media asset recommendations based on a virtual environment. For example, the MGA may generate for display an icon (e.g., “recommend movies based on virtual reality”) for a user, and subsequently instructs the VEE to determine preferences of the user based on the user's virtual environment.

In some embodiments, the VEE may determine the user's virtual environment based on all of the virtual objects in the virtual environment, or a subset thereof. The VEE may, in some aspects, compute one or more preference metrics for the user based on metadata associated each virtual object. As previously illustrated, the metadata associated with each virtual object may be the coordinates, location, genre, function, structure, appearance or any other information associated with the virtual object. For example, the VEE may analyze a virtual poster placed in a prominent location in the virtual bedroom for the user (e.g., virtual poster 508), and determine that the user may be a fan of the celebrity character shown on the virtual poster based on the fact that the virtual poster is being placed in a prominent location. As a result, the VEE may generate a list of tags (e.g., as preferences of the user), such the name of the celebrity character, other similar celebrity characters, and movies that the celebrity character appears in, to send to the MGA for recommendation of media assets.

In some other embodiments, the VEE may analyze virtual objects in relation to each other in the virtual environment in order to determine preferences of the user. For example, the VEE may determine that a virtual bicycle is placed next to a box of virtual biking gears in the user's virtual environment. In this example, the VEE may determine that the user is a biking enthusiast, and communicate tags that relate to biking, such as “Tour de France” and “Lance Armstrong”, to the MGA for media asset recommendations. The MGA may, in turn, recommend documentaries on Lance Armstrong or upcoming screenings of the Olympics Game to the user.

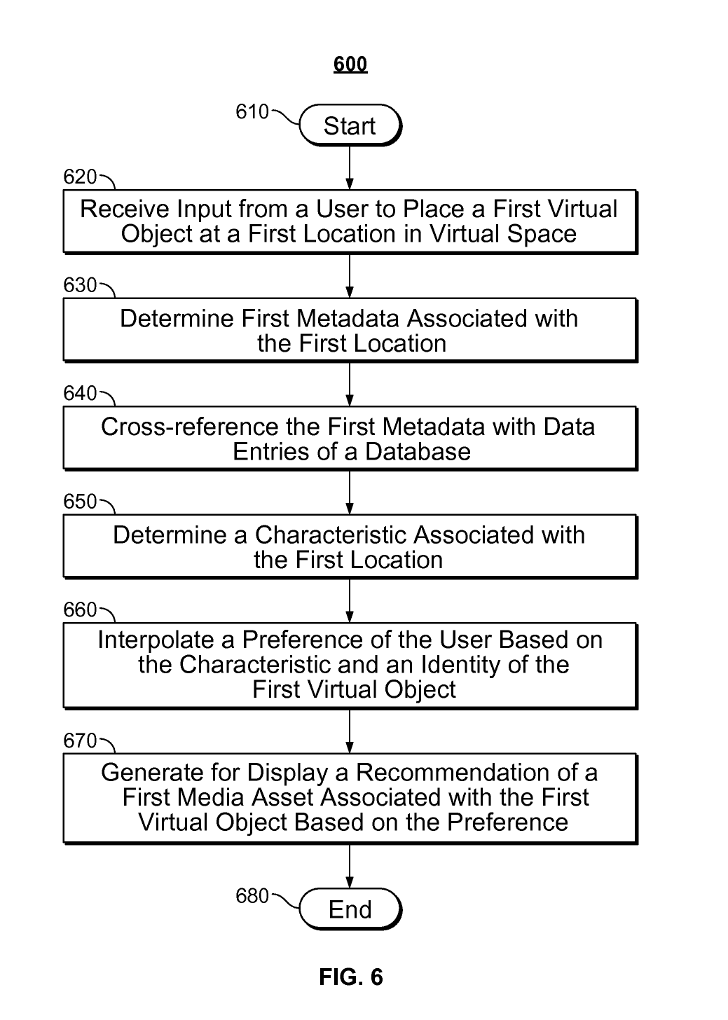

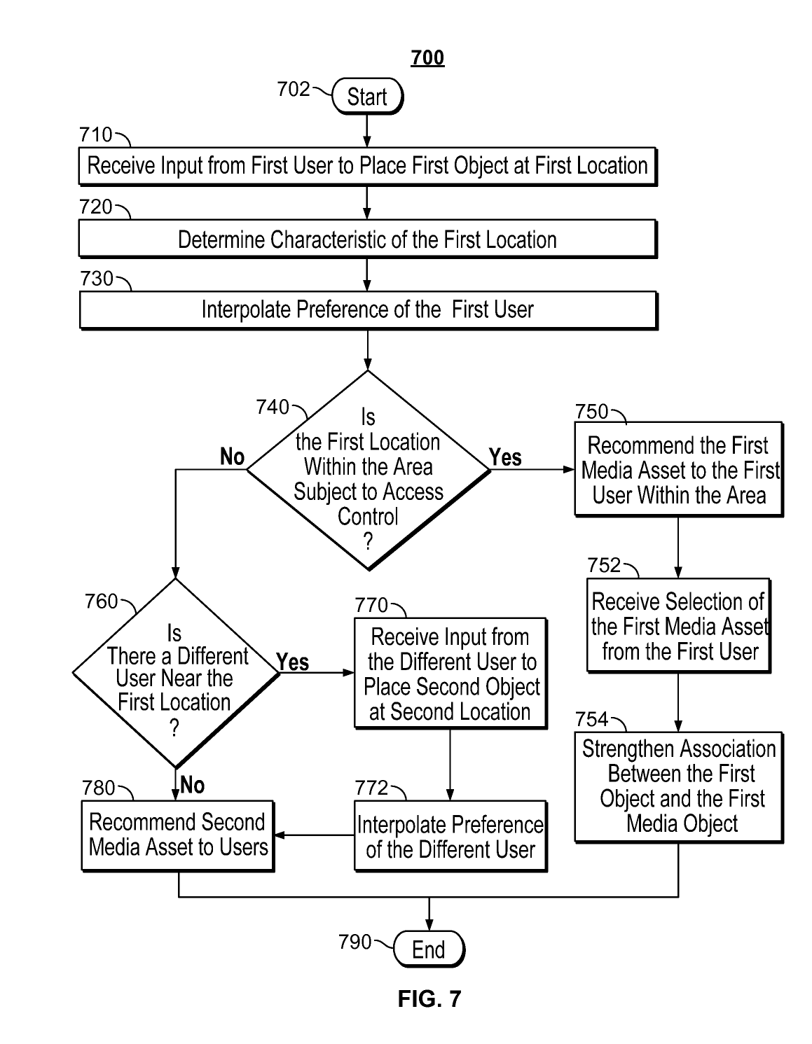

FIG. 6 is a flowchart of illustrative steps involved in providing virtual recommendations based on properties of virtual objects, in accordance with some embodiments of the disclosure. It should be noted that process 600 or any step thereof could be performed on, or provided by, any of the devices shown in FIGS. 3-4. For example, process 600 may be executed by control circuitry 304 (FIG. 3) as instructed by control circuitry implemented on user equipment 402, 404, and/or 406 (FIG. 4) in order to provide virtual recommendations based on properties of virtual objects. In addition, one or more steps of process 600 may be incorporated into or combined with one or more steps of any other process or embodiment (such as process 700 of FIG. 7).

Process 600 begins at 610 and proceeds to 620, where a VEE running on control circuitry (e.g., control circuitry 304) may determine that user input circuitry (e.g., user input interface 310) has received input from a user to place a first virtual object at a first location in virtual environment. For example, the VEE may determine that the user has placed a virtual collection of anime posters inside virtual closet 512 of the virtual environment. Process 600 may then continue to 630.

At 630, the VEE may determine first metadata associated with the first location. For example, the VEE may determine that the coordinates of virtual closet 512 within the virtual environment are (x1, y1). In some embodiments, the VEE determines the metadata by analyzing known information of the first location without consulting a database. In the above example, the metadata associated with virtual closet 512 is therefore the coordinates of virtual closet 512, (x1, y1). Process 600 then proceeds to 640.

At 640, the VEE may cross-reference the first metadata with data entries of a first database (e.g., a VODB), such as storage 308 or media guidance data source 418. For example, the VEE may cross-reference the coordinates of virtual closet 512, (x1, y1,), with data entries in the VODB implemented on local storage 308, in order to find a match. In some embodiments, the VEE searches the first database with the query string comprising the first metadata obtained previously. Process 600 then proceeds to 650.

At 650, the VEE determines a characteristic associated with the first location. In some embodiments, the characteristic may be a property of the first location, a description of the first location, a name of the first location, a function of the first location, or any other data that can be used to provide further information about the first location. For example, the VEE may determine, based on the cross-referencing, that a characteristic associated with virtual closet 512 may be “private and hidden.” The VEE may obtain the characteristic by querying the first database (e.g., the VODB) and analyzing the returned data block from the first database for descriptive texts of the first location. In the above example, the returned data block may contain a property field with the descriptive text “private and hidden.” Accordingly, the VEE may determine that one of the characteristics associated with virtual closet 512 may be “private and hidden.” Process 600 then proceeds to 660.

At 660, the VEE may interpolate a preference of the user based on the characteristic and an identity of the first virtual object. In some embodiments, the identity of the first virtual object may be genre, category, tag, or other descriptive texts associated with the first virtual object. In some embodiments, the VEE may obtain the identity of the first virtual object by querying the first database (e.g., the VODB). For example, the VEE may determine that the identity of the anime posters of the user may be “anime.” Based on the characteristic of “private and hidden” for virtual closet 512 and the identity of “anime” for the anime posters, the VEE may interpolate a preference of the user as “watch Japanese anime in private.” In some embodiments, the interpolation may be performed by the VEE by querying a cloud-based server, such as media guidance data source 418. In some embodiments, the VEE performs the interpolation based on a localized algorithm, such as a natural language processing algorithm, in order to calculate the preference of the user. Process 600 then proceeds to 670.

At 670, the VEE sends the interpolated preference of the user to the MGA in order for the MGA to generate for display a recommendation of a first media asset associated with the first virtual object based on the interpolated preference. In some embodiments, the MGA queries a second database (e.g., an MDB, such as media guidance data source 418) based on the interpolated preference in order to search for media assets to recommend. The MGA may use the interpolated preference of the user, the characteristic of the virtual location, and the identity of the virtual object as search strings to find matching media assets in the second database and provide the matching media assets as recommendations. For example, based on the preference of watching Japanese anime in private, the MGA may generate for display a recommendation for a new episode of Japanese anime for the user to consider purchasing, recording, or scheduling a reminder for. Process 600 then ends at 680. Although the present process is illustrated with “a recommendation” being generated for display, one or more recommendations may be presented, as is understood by one skilled in the art.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 6.

FIG. 7 is a flowchart of illustrative steps involved in recommending media assets to one or more users based on user preferences, in accordance with some embodiments of the disclosure. It should be noted that process 700 or any step thereof could be performed on, or provided by, any of the devices shown in FIGS. 3-4. For example, process 700 may be executed by control circuitry 304 (FIG. 3) as instructed by control circuitry implemented on user equipment 402, 404, and/or 406 (FIG. 4) in order to determine whether a first area is within an area subject to access control. In addition, one or more steps of process 700 may be incorporated into or combined with one or more steps of any other process or embodiment (such as process 600 of FIG. 6).

Process 700 begins at 702 and proceeds to 710, wherein a VEE running on control circuitry (e.g., control circuitry 304) may determine that user input circuitry (e.g., user input interface 310) has received input from a first user to place a first object at a first location. As an example, a first user may use keyboard associated with user computer equipment 404 to access a virtual environment and place a virtual collection of anime inside virtual closet 512. Process 700 may then continue to 720.

At 720, the VEE may determine a characteristic of the first location. For example, the VEE may determine that virtual closet 512 is defined by the first user to be a “personal” location. At 740, the VEE may interpolate a preference of the first user based on the characteristic of the first location. In some embodiments, the preference of the first user is a preference for media assets. For example, the VEE may interpolate, based on the “personal” characteristic of virtual closet 512, that the first user has a preference for “watching Japanese anime during personal time.” Process 700 then proceeds to decision block 740.

At 740, the VEE may determine whether the first location is within an area subject to access control. As illustrated previously, an area is subject to access control by a user if the area is owned by the user or otherwise defined by the user to be inaccessible by other users. For example, the private home of a user may be an area subject to access control. In the foregoing example, the VEE may determine that virtual closet 512, having a “personal” characteristic, is a private and hidden virtual location that is subject to access control. Process 700 then proceeds to 750. If, however, the VEE determines that a particular location is not within the area subject to access control, process 700 proceeds to 760.

At 750, the MGA receives the user's preference for media assets from the VEE and recommends a first media asset to the first user within the area subject to access control. As previously described in relation to FIG. 6, the MGA may recommend the first media asset by querying a media asset database using the interpolated preference of the user. For example, the MGA may recommend a new episode of an anime to the user, based on query results obtained by searching the MDB (e.g., media guidance data source 418) with the interpolated preference for “watching Japanese anime during personal time.” Process 700 then proceeds to 752.

At 752, the MGA may determine that a user selection of the first media asset from the first user has been received, e.g., by user input interface circuitry 310. The user selection of the first media asset may be a user request to access, purchase, or rent the second object. For example, the MGA may determine that the first user has scheduled the recommended new episode on a television equipment device, such as user television equipment device 402. Process 700 then proceeds to 754.

At 754, the VEE or the MGA may strengthen an association between the first object and the first media asset as a result of the first user's selection of the recommended first media asset. In particular, the VEE may determine that the user's selection of the recommended first media asset may indicate that the existing association between the first virtual object and first media asset needs to be reinforced with positive feedback. For example, the VEE may indicate in the first database (e.g., a VODB) that the association index between “anime poster” and the “recommended new episode of Japanese anime” should be increased as a result of the first user's selection to schedule the recommended new episode for viewing. Process 700 then ends at 790.

At 760, after determining that the first location is not within the area subject to access control, the VEE may further determine whether a different user is near the first location. For example, the VEE may determine that a virtual living room is not subject to access control, and that a first user and a second user are near the virtual living room. In some embodiments, the VEE may determine that the first and second users are near the virtual living room by calculating a proximity value of each user with respect to the virtual living room. If at least one other user is near the first location, process 700 proceeds to 770. Otherwise, if no other user is near the first location, process 700 proceeds to 780.

At 770, the VEE may determine that input from the different (second) user to place a second object at a second location has been received, e.g., by user input interface circuitry 310. For example, the second user may place a poster of Star Wars characters in a shared library in the virtual environment. Process 700 then proceeds to 772.

At 772, the VEE may interpolate a preference of the different (second) user based on the characteristic of the second object as well as the second location. For example, the VEE may interpolate, based on the characteristic of “science fiction” for the Star Wars poster and the characteristic of “public” for the library, that the second user has a preference for “viewing science fiction movies in public.” Process 700 then proceeds to 780.

At 780, the MGA may obtain the preference of the second user, the characteristic of the second virtual object, and the characteristic of the second location from the VEE, and may generate for display a recommendation of a media asset based on known preferences of all users present at the second location. In the event that two or more users are present at the given location (e.g., both the first and the second users are present, at the virtual library), the MGA may recommend a second media asset to all of the users. If, however, only one user (e.g., the first user) is present at the given location, the MGA may recommend a second media asset to the only user. For example, if both the first and the second users are present at the virtual library, as determined by the VEE and communicated to the MGA, the MGA may recommend an episode of Mobile Suit Gundam SEED to both the first user (based on his or her preference for “watching an episode of Japanese anime”) and the second user (based on his preference for “viewing science fiction movies.” As another example, if only the first user is present at the virtual library, the MGA may recommend a title of Japanese manga that does not necessarily fall into the category of science fiction movies. Process 700 then proceeds to end at 790.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 7.

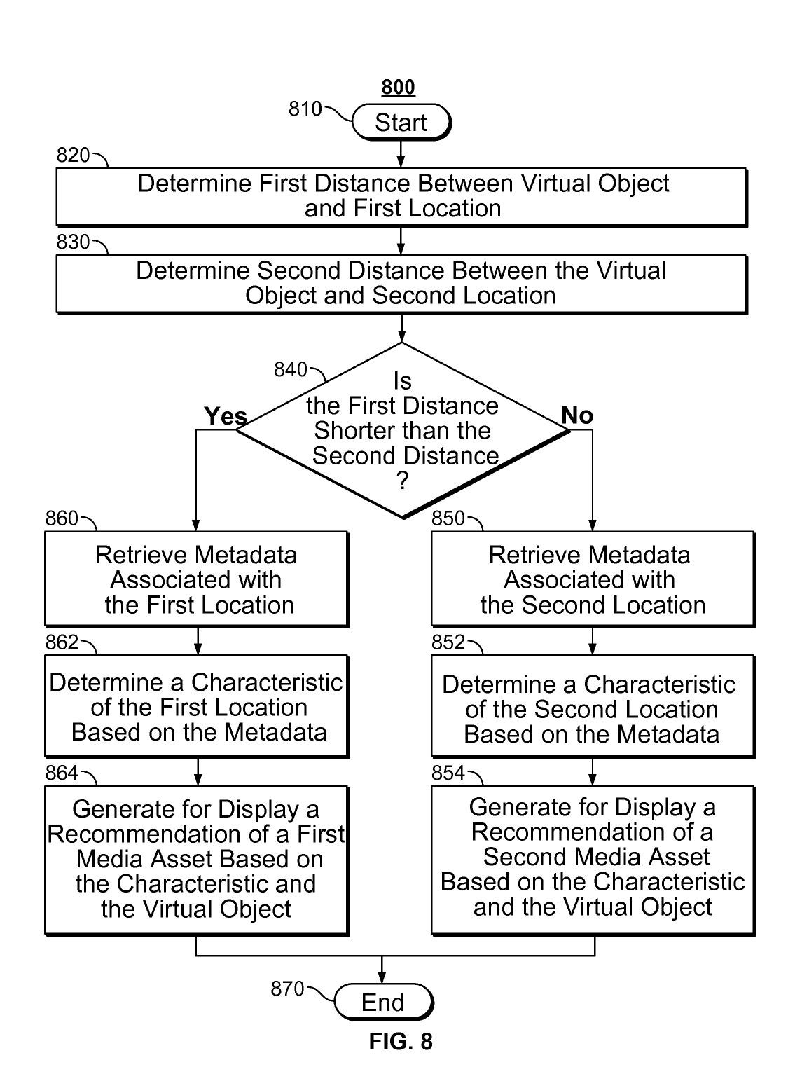

FIG. 8 is a flowchart of illustrative steps involved in recommending media assets to one or more users based on relative distances of virtual objects and various locations in a virtual environment. Process 800 begins at 810 and proceeds to 820, where a VEE running on control circuitry determines a first distance between a virtual object and a first location. For example, the VEE may determine that an anime poster that the user has placed in a virtual environment is 5 units of distance away from a first virtual location (e.g., virtual bed 502).

At 830, the VEE determines a second distance between the virtual object and a second location. For example, the VEE may determine that the anime poster may be 3 units of distance from a second virtual location (e.g., virtual electronic device 510). Process 800 then proceeds to decision block 840.

At 840, the VEE determines whether the first distance is shorter than the second distance. For example, the VEE determines that the anime poster's distance from the first virtual location (i.e., 5 units of distance) is not shorter than its distance from the second virtual location (i.e., 3 units of distance). In this example, process 800 proceeds to 850. If, however, the anime poster's distance from the first virtual location is shorter than its distance from the second virtual location, process 800 will proceed to 850.

At 850, the VEE retrieves metadata associated with the second virtual location. For example, the VEE may retrieve, from a virtual objects database (e.g., a VODB, such as storage 308), an identity of the second virtual location. The identity of the second virtual location may be a virtual computer, such as virtual electronic device 510.

At 852, the VEE may determine a characteristic of the second virtual location based on the retrieved metadata. For example, the VEE may determine, based on the fact that the second virtual location is a virtual computer, that second virtual location is associated with a working event. For example, the VEE may determine that the user only uses virtual computers for work-related events in the virtual environment, and therefore virtual objects placed in the proximity of virtual computers may be used to generate recommendations of media assets while the user is performing a working event, either within or outside of the virtual environment. In some embodiments, the recommendation of media assets can be performed by a media guidance application (MGA) either within or outside of the virtual environment.

At 854, the MGA may receive an identity of the virtual object and characteristics related to the second virtual location, in order to generate for display a recommendation of a second media asset based on the identity and the characteristics. In some embodiments, the MGA queries a media database (e.g., an MDB, such as media guidance data source 418) using the identity and the characteristics information and retrieves a list of media assets which are tagged with the identity and characteristics information. For example, the MGA may generate a related anime for display for the user based on the virtual anime poster. In addition, based on the characteristics of the second virtual location (i.e., the virtual computer), the MGA may generate the related anime for display while the user is working on a personal computer, such as on user computer equipment 404. The recommendation of the related anime may be in the form of a pop-up window or an email. For example, the MGA may direct an email containing a link to the recommended related anime to the user while the user is working on user computer equipment 404.

At 860, when the VEE determines that the first distance is shorter than the second distance, the VEE may retrieve metadata associated with the first virtual location. For example, the VEE may retrieve, from the first database (e.g., the VODB), coordinates of the first virtual location (e.g., virtual bed 502).

At 862, the VEE may determine a characteristic of the first virtual location based on the retrieved metadata. For example, the VEE may determine that virtual bed 502 has a characteristic of being associated with the event of sleeping at night.

At 864, the MGA may receive an identity of the virtual object and characteristics related to the first virtual location, in order to generate for display a recommendation of a first media asset based on the characteristic and the virtual object. For example, the VEE may determine that the user only places virtual objects relevant to the event of sleeping in the proximity of virtual bed 502, and communicates this information to the MGA. Consequently, the MGA may determine that a Japanese evening talk show is relevant to the event of sleeping, based on the virtual anime poster and the sleeping event characteristic of virtual bed 502. The MGA may generate for display to the user, either within the virtual environment or on a user equipment capable of displaying video assets, a recommendation for the Japanese evening talk show.

While the above disclosure in relation to FIG. 8 is made with respect to relative distances between virtual objects and virtual locations, it is understood that other relative distances may be used, in a similar manner, to determine preferences of users and to make recommendations of media assets. For instance, relative distances between virtual objects and relative distances between virtual locations, may be used. In some embodiments, the examples of virtual locations in the above disclosure—virtual bed 502 and virtual electronic device 510—may be considered “virtual objects” rather than “virtual locations.”

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 8. For example, a virtual storage space, such as a cloud-based storage solution as described in relation to FIG. 4, may be used to implement the database or store characteristics information associated with the virtual objects and virtual locations.

It will be apparent to those of ordinary skill in the art that methods involved in the present invention may be embodied in a computer program product that includes a computer-usable and/or readable medium. For example, such a computer-usable medium may consist of a read-only memory device, such as a CD-ROM disk or conventional ROM devices, or a random access memory, such as a hard drive device or a computer diskette, having a computer-readable program code stored thereon. It should also be understood that methods, techniques, and processes involved in the present invention may be executed using processing circuitry. For instance, determination of a conceptual boundary, e.g., by processing circuitry 306 of FIG. 3. The processing circuitry, for instance, may be a general purpose processor, a customized integrated circuit (e.g., an ASIC), or a field-programmable gate array (FPGA) within user equipment 300, media content source 416, or media guidance data source 418. For example, the media stream as described herein may be stored in, and retrieved from, storage 308 of FIG. 3, or media guidance data source 418 of FIG. 4. Furthermore, processing circuitry, or a computer program, may update settings associated with a user, such as user profile preferences, updating the information stored within storage 308 of FIG. 3 or media guidance data source 418 of FIG. 4.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for providing media asset recommendations based on properties of virtual objects, the method comprising:
receiving input from a user to place a first virtual object at a first location in a virtual environment;
determining an identity of the first virtual object;
determining first metadata associated with the first location;
determining, based on the first metadata, that the first location is a private location;
based on the determination that the first location is the private location and the placement of the first virtual object at the first location, determining that the user has a preference to use the first virtual object in private;
based on the preference, identifying a private recommendation of a first media asset associated with the first virtual object;
determining whether the user is in the private location in the virtual environment;
based on a determination that the user is in the private location, generating the private recommendation for display in the private location such that users who are not entitled to access the private location are not able to view the private recommendation; and
based on a determination that the user is in a public location in the virtual environment, generating a public recommendation of a second media asset for display in the public location.

2. The method of claim 1, further comprising:
determining whether the user has accessed the first media asset subsequent to when the private recommendation is generated for display; and
strengthening an association between the first virtual object and the first media asset based on determining that the user has accessed the first media asset.

3. The method of claim 2, further comprising:
strengthening an association between the first virtual object and the first location based on determining that the user has accessed the first media asset.

4. The method of claim 1, further comprising:
receiving input from the user to move the first virtual object from the first location to a second location in the virtual environment;
determining second metadata associated with the second location;
and
determining, based on the second metadata, a characteristic associated with the second location, wherein, based on the characteristic, the public recommendation of the second media asset is generated for display.

5. The method of claim 4, further comprising:
receiving input from a different user to place a second virtual object at the second location;
interpolating a preference of the different user based on the characteristic associated with the second location and an identity of the second virtual object;
correlating the preference of the user with the preference of the different user to calculate a shared preference metric between the user and the different user, wherein, based on the shared preference metric, a recommendation of a third media asset is generated for display for both the user and the different user.

6. (canceled)

7. (canceled)

8. The method of claim 1, further comprising:
determining a first distance between the first virtual object and the first location;
determining a second distance between the first virtual object and a second location;
determining that the second distance is shorter than the first distance;
retrieving second metadata associated with the second location from a database; and
determining, based on the second metadata, a characteristic associated with the second location, wherein, based on the characteristic and the identity of the first virtual object, the public recommendation of the second media asset is generated for display.

9. The method of claim 1, further comprising:
receiving, from the user, a selection of a scene from a media asset;
generating a virtual representation of the scene based on the selection; and
adding the virtual representation of the scene to the virtual environment.

10. The method of claim 1, wherein the private recommendation of the first media asset is generated for display by:
receiving, with a media guidance application from a virtual environment engine, the preference of the user;
querying a media guidance database, with the media guidance application, for media assets associated with the first virtual object based on the preference of the user;
retrieving, from the media guidance database, an identifier of the first media asset; and
generating for display the identifier of the first media asset.

11. A system for providing media asset recommendations based on properties of virtual objects, the system comprising:
storage circuitry configured to store data entries associated with virtual objects and locations in a virtual environment;
user input circuitry configured to receive an input from a user to place a first virtual object at a first location in the virtual environment; and
control circuitry configured to:
determine an identity of the first virtual objection;
determine first metadata associated with the first location;
determine, based on the first metadata, that the first location is a private location;
based on the determination that the first location is the private location and the placement of the first virtual object at the first location, determine that the user has a preference to use the first virtual object in private;
based on the preference, identify a private recommendation of a first media asset associated with the first virtual object;
determine whether the user is in the private location in the virtual environment;
based on a determination that the user is in the private location, generate the private recommendation for display in the private location such that users who are not entitled to access the private location are not able to view the private recommendation; and
based on a determination that the user is in a public location in the virtual environment, generate a public recommendation of a second media asset for display in the public location.

12. The system of claim 11, wherein the control circuitry is further configured to:
determine whether the user has accessed the first media asset subsequent to when the private recommendation is generated for display; and
strengthen an association between the first virtual object and the first media asset based on determining that the user has accessed the first media asset.

13. The system of claim 12, wherein the control circuitry is further configured to:
strengthen an association between the first virtual object and the first location based on determining that the user has accessed the first media asset.

14. The system of claim 11, wherein:
the user input circuitry is further configured to receive input from the user to move the first virtual object from the first location to a second location in the virtual environment; and
the control circuitry is further configured to:
determine second metadata associated with the second location;
and
determine, based on the second metadata, a characteristic associated with the second location, wherein, based on the characteristic, the public recommendation of the second media asset is generated for display.

15. The system of claim 14, wherein:
the user input circuitry is further configured to receive input from a different user to place a second virtual object at the second location; and
the control circuitry is further configured to:
interpolate a preference of the different user based on the characteristic associated with the second location and an identity of the second virtual object; and
correlate the preference of the user with the preference of the different user to calculate a shared preference metric between the user and the different user, wherein, based on the shared preference metric, a recommendation of a third media asset is generated for display for both the user and the different user.

16. (canceled)

17. (canceled)

18. The system of claim 11, wherein the control circuitry is further configured to:
determine a first distance between the first virtual object and the first location;
determine a second distance between the first virtual object and a second location;
determine that the second distance is shorter than the first distance;
retrieve second metadata associated with the second location from a database; and
determine, based on the second metadata, a characteristic associated with the second location, wherein, based on the characteristic and the identity of the first virtual object, the public recommendation of the second media asset is generated for display.

19. The system of claim 11, wherein:
the user input circuitry is further configured to receive, from the user, a selection of a scene from a media asset; and
the control circuitry is further configured to:
generate a virtual representation of the scene based on the selection; and
add the virtual representation of the scene to the virtual environment.

20. The system of claim 11, wherein the control circuitry is further configured to generate for display the private recommendation of the first media asset by:
receiving, with a media guidance application from a virtual environment engine, the preference of the user;
querying a media guidance database, with the media guidance application, for media assets associated with the first virtual object based on the preference of the user;
retrieving, from the media guidance database, an identifier of the first media asset; and
generating for display the identifier of the first media asset.

21-50. (canceled)
